(19) United States
(12) Patent Application Publication
(10) Pub. No.: US 2025/0259306 A1
(43) Pub. Date: Aug. 14, 2025

(54) A SYSTEM OF IDENTIFYING PLURALITY OF PARAMETERS OF A SUBJECT'S SKIN AND A METHOD THEREOF

(71) Applicant: Suruchi Garg, Chandigarh (IN)

(72) Inventor: Suruchi Garg, Chandigarh (IN)

(21) Appl. No.: 18/856,437

(22) PCT Filed: Apr. 12, 2023
(86) PCT No.: PCT/IN2023/050359

§ 371 Date: Oct. 11, 2024

(30) Foreign Application Priority Data
Apr. 13, 2022 (IN) 202211022253

(51) Int. Cl. G06T 7/00; G06T 17/00

(52) U.S. Cl. CPC G06T 7/0014; G06T 17/00; G06T 2207/30088; G06T 2210/41

(57) ABSTRACT

The present disclosure provides a system (100) of identifying a plurality of parameters related to abnormalities in a subject's skin. The system (100) comprises a scanner (110), a remodeling processor, a control unit (120), a prediction processor, one or more energy projecting systems (140) and a touch-screen panel (130). The scanner (110) is configured to scan a 2D image of the subject's skin from multiple angles to capture one or more feature points. The remodeling processor is configured to construct a 3D model of the subject's skin. The control unit (120) comprising a prediction processor configured to determine a first set of parameters and a second set of parameters and the plurality of parameters. The touch-screen panel (130) is configured to display the plurality of parameters to a physician/user.

### FIELD OF DISCLOSURE

The present disclosure generally relates to system and method for identifying a plurality of parameters. More particularly, the present disclosure relates to a system and method of identifying a plurality of parameters related to abnormalities in a subject's skin.

### BACKGROUND

Our skin has up to seven layers of ectodermal tissue which guards the underlying muscles, bones, ligaments, and internal organs. The discrete compartments of underlying fat planes and muscles in our face gives the structural design of the human face. These compartments are separated by condensations of the superficial fascia along with dense dermal attachments. The nasolabial fold commonly known as smile or laugh lines is a discrete unit with distinct anatomical boundaries. The malar fat is composed of three separate compartments: medial, middle, and lateral temporal-cheek fat. The orbital fat is divided in three compartments determined by septal borders, the superior, inferior, and lateral orbital fat pads. Jowl fat is the most inferior of the subcutaneous fat compartments (Rohrich R J, Pessa J E., PlastReconstr Surg. 2007 June; 119 (7): 2219-27; discussion 2228-31).

Aging of the skin is a natural phenomenon which starts appearing in all the layers of face beginning from skin, fat lobules, muscle to the underlying bones. Wrinkles are created in skin due to the breakdown of collagen fibers and due to the penetration of fat into the dermal layer of the skin and can be categorized as superficial wrinkles, mimetic wrinkles, and folds (Lemperle G, Holmes R E, Cohen S R, et al., PlastReconstr Surg.2001;108:1735-1750). In general, ageing process causes a decrease in collagen generation, skin versatility, and eventually lead to the appearance of puffy face along with sagging skin, puffy eyelids, and excess fat bags around the area of eyes. Besides ageing, there are several other reasons that are responsible for causing deformities on the face which includes variable physical, chemical, and biological causes such as sun exposure, injuries, deep wound, congenital disorders, acquired diseases, traumatic and developmental deformities and many more.

It has long been known that damaging collagen will cause shrinkage and healing occurs by formation of new collagen or neocollagenesis (rejuvenation). It has been shown that the physiology allows excellent clinical results that allows physicians and device companies to serve subjects profitably but some conventional existing technologies such as lifting surgery and massaging devices and are not able to accurately control where to apply the therapeutic treatment, depth of penetration, or how much therapeutic energy is to be projected by the system. The invasive surgical techniques such as rhytidectomy, blepharoplasty, facial fat transplantation, liposuction, fillers, botulinum toxin injections, thread lifts, or laser-abrasion, silicone implants, injectable fillers have their own set of drawbacks can cause toxicity, infection, skin injury, persistent pigmentation, and may severely damage the nerve cells, may cause vascular occlusion or granulomatous reactions due to foreign body reaction or may lead to several other diseases or disorders.

The use of fillers, toxic external agents in minimal invasive surgery to restructure the facial appearance can cause the risk of foreign body reaction, granuloma formations, vascular complications, or infections. For example, injection of botulin toxin treatments in over dosage can cause paralysis and disfigurement. The use of deep chemical peel may damage the epidermis. In the traditional face-lifting surgery, the skin incisions are made through the epidermis which may damage or scar the epidermis and its component structures causing undesirable discoloration to the skin. Generally, the invasive methods require a week or more as post-operative recovery period and also coupled with the danger of damage to internal tissues or nerves sometimes. The use of anesthesia, surgical complications and the overall cost of the surgery is a disadvantage to the invasive procedures.

Facial and neck skin remodeling has traditionally been addressed using surgical or face lifting procedures by fat transfer and filling of facial adipose tissue, which has made it possible to give a fresh topography to the face and eyelid area. Later, the non-surgical or non-invasive procedures have been developed with the utilization and application of radiofrequency (RF), focused ultrasound and ablative lasers. On other hand, there are many primary approaches being pursued by conventional systems to deal with this kind of problem wherein the system comprises a hand-held device with at least one vibrating element, ultrasound probe or any other acoustic power source which is disposed at an end of the devices for heating of facial fat are well known in the prior art and have been incorporated into many known objects. Such hand-held manually operated devices are generally used by people who need temporary relief from sore or strained adipose layer.

However, these techniques are not feasible and long-lasting solution for identifying abnormalities in a subject's skin. The hand-held portable device is not precise and dimensionally accurate. The chances of error and asymmetric re-positioning of the heated fat lobules is very high as the direction of applying hand pressure and movement of the probe is completely dependent on the user manipulation.

Hence, there is a need to develop a novel, cost-effective, automated system, and method for identifying a plurality of parameters related to abnormalities in the subject's skin.

### SUMMARY

The primary objective of the present disclosure is to provide a novel, automatic system, and method for identifying a plurality of parameters related to abnormalities in a subject's skin.

Yet another objective of the present disclosure is to provide a system comprising a technique for filling hollowed and flattened portions of the face without the use of fillers, fat grafting, external lotions, or other skin rejuvenating agents.

To achieve the above objectives, the present disclosure provides a system comprising a scanner for scanning and capturing contours of the subject's skin from multiple angles and a remodeling processor for constructing 3D image of skin, a control unit comprising a prediction processor for predicting or determining sagging or fat loss in a particular area and determining a plurality of parameters which are selected from the group consisting of temperature, pressure, time duration, intensity of energy applied, angular motion, direction of movement and combinations thereof. Further, the plurality of parameters are calculated based on the data obtained from the remodeling processor, and one or more energy projecting systems for directing the plurality of parameters determined by the control unit on the fat planes on the identified area of the subject's skin.

In an embodiment of the present disclosure, the system of identifying a plurality of parameters related to abnormalities in a subject's skin. The system comprises a scanner, a remodeling processor, a control unit, a prediction processor and a touch-screen panel. The scanner is configured to scan a 2D image of the subject's skin from multiple angles to capture one or more feature points. Further, the one or more feature points corresponds to physical attributes of the subject. The remodeling processor is configured to construct a 3D model of the subject's skin by depth estimation of the 2D image to form a new image and depth-based rendering of the new image to form a stereo pair. Furthermore, the control unit comprises a prediction processor. The prediction processor is configured to determine a first set of parameters and a second set of parameters corresponding to the one or more feature points. The touch-screen panel is configured to display the plurality of parameters to a physician/user. Moreover, the plurality of parameters are determined by the prediction processor using the first set of parameters and the second set of parameters.

In an embodiment of the present disclosure, the system comprises one or more energy projecting systems. The one or more energy projecting systems are configured to direct the plurality of parameters displayed by the touch-screen panel on the fat planes that are identified on the subject's skin.

In an embodiment of the present disclosure, the system is configured to enhance an efficacy by iterative use of the system based on the plurality of parameters.

In an embodiment of the present disclosure, the first set of parameters and the second set of parameters corresponds to properties of a reference model and a test model of the subject respectively.

In an embodiment of the present disclosure, the remodeling system comprises an artificial intelligence (AI) algorithm for comparing a reference model with a test model for obtaining the plurality of parameters.

In an embodiment of the present disclosure, the reference model corresponds to a non-real time model of the subject and the test model corresponds to a real-time model of the subject.

In an embodiment of the present disclosure, the system further comprises the remodeling processor having a supervised learning algorithm that adjusts or reconstructs the face using texture mapping to produce a preliminary test model that allows the user or physician to re-structure or re-model the facial fat planes as needed.

In an embodiment of the present disclosure, the control unit of the system collects data from the remodeling processor and predicts the fat loss and migration from a treatment area and the plurality of parameters required for facial fat repositioning. The plurality of parameters are selected from the group consisting of magnitude and intensity of energy and pressure, temperature, degree angle for movement of probe, time duration, number of repetitions of the procedure, number of sessions and combinations thereof. Further, the control unit sends (e.g., transmits or directly transmits) the signal based on the plurality of parameters to the one or more energy projecting systems to perform skin rejuvenation.

In an embodiment of the present disclosure, the plurality of parameters are applied to the subcutaneous fat and facial skin using one or more energy projecting systems that are either connected to hand-held devices or an automatic robotic system. In one exemplary embodiment, heat and pressure are applied to the treatment area where the heating improves the trans-membrane permeation of fatty acids in fat lobules and makes the fat more receptive to movement on pressure. The one or more energy projecting systems applies heat and pressure on to the subcutaneous fat of the facial skin to relocate the heated fat lobules towards temporal, malar, and sub-orbital areas by filling the hollowed and flattened areas of the face and effacing the nasolabial and mesomental folds.

In an embodiment of the present disclosure, the control unit of the system further comprises a touch-screen panel that guides the physician to follow the path displayed on the screen for rejuvenation.

In an embodiment of the present disclosure, the touch-screen panel displays the ongoing plurality of parameters like temperature, pressure, and treatment area.

In another embodiment of the present disclosure, the system is used for rejuvenating the skin of the skin area, e.g., face, neck, jowls, and the like, by using energy-based devices which work by selectively heating the skin and fat layers leading to neocollagenesis by fibroblasts activation and condensation of fat compartments by thickening of septae and fibrous bands. The present disclosure further comprises a system of re-positioning the fat planes that have migrated down, back on to their original places and to fill the hollowed and flattened areas of the facial skin without the use of fillers, fat grafting, dermal abrasion, external lotions, or other skin rejuvenating agents. Further, the system involves the movement of the fat settled around nasolabial fold, jaw line and jowls towards temporal and malar areas and to fill the hollow periorbital areas using one or more soft round and spherical like projection in the movable arm tip.

In yet another embodiment of the present disclosure, the system of identifying the plurality of parameters comprises a remodeling system and an automatic moveable bed system.

Therefore, the advantages of the present disclosure is advantageous for providing a novel system for identifying the plurality of parameters related to abnormalities in the subject's skin. The system is less time consuming, accurate, automatic and effective for providing the plurality of parameters related to abnormalities in the subject's skin.

### BRIEF DESCRIPTION OF FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates a block diagram of a system in accordance with the present disclosure.

FIG. 2 illustrates an exemplary bar graph showing the number of subjects improving after the therapy with respect to the initial ones (before therapy) in terms of temporal hollowness in accordance with the present disclosure.

FIG. 3 illustrates an exemplary bar graph showing the number of subjects improving after the therapy with respect to the initial ones (before therapy) in terms of malar flattening in accordance with the present disclosure.

FIG. 4 illustrates an exemplary bar graph showing the number of subjects improving after the therapy with respect to the initial ones (before therapy) in terms of periorbital hollowness in accordance with the present disclosure.

FIG. 5 illustrates an exemplary bar graph showing the number of subjects improving after the therapy with respect to the initial ones (before therapy) in terms of periorbital puffiness in accordance with the present disclosure.

FIG. 6 illustrates an exemplary bar graph showing the number of subjects improving after the therapy with respect to the initial ones (before therapy) in terms of changes in the jowl region in accordance with the present disclosure.

FIG. 7 illustrates an exemplary bar graph showing the number of subjects improving after the therapy with respect to the initial ones (before therapy) in terms of nasolabial fold in accordance with the present disclosure.

FIG. 8 illustrates an exemplary bar graph showing the percentage change in the respective facial area compartment after the therapy in accordance with the present disclosure.

FIG. 9A illustrates an exemplary ultrasound depiction of the medial side of periorbital area before and immediately after the therapy in accordance with the present disclosure.

FIG. 9B illustrates an exemplary ultrasound depiction of the nasolabial fold depth till fat layer before and after the therapy in accordance with the present disclosure.

FIG. 10 illustrates an exemplary flowchart illustrating a method for identifying a plurality of parameters related to abnormalities in the subject's skin in accordance with the present disclosure.

### LIST OF REFERENCE NUMERALS

100—system
110—scanner
120—control unit
130—touch-screen panel
140—one or more energy projecting systems

### DETAILED DESCRIPTION

In the following description, various aspects of the disclosure will be described. For the purposes of explanation, specific details are set forth in order to provide a thorough understanding of the disclosure. It will be apparent to one skilled in the art that there are other embodiments of the disclosure that differ in detail without affecting the essential nature thereof. It is to be understood that other embodiments can be used, and structural changes can be made without departing from the scope of the embodiments of this disclosure.

Reference will now be made to the embodiments. It will nevertheless be understood that no limitation of the scope of the disclosure is thereby intended. Alterations and further modifications of the inventive features illustrated herein, and additional applications of the principles of the disclosure as illustrated herein, which would occur to one, skilled in the relevant art and having possession of this disclosure, are to be considered within the scope of the disclosure.

As used herein, the term ‘exemplary’ or ‘illustrative’ means ‘serving as an example, instance, or illustration.’ Any implementation described herein as exemplary or illustrative is not necessarily to be construed as advantageous and/or preferred over other embodiments. Unless the context requires otherwise, throughout the description and the claims, the word ‘comprise’ and variations thereof, such as ‘comprises’ and ‘comprising’ are to be construed in an open, inclusive sense, i.e., as ‘including, but not limited to.’

This disclosure is generally drawn, inter alia, to methods, apparatuses, systems, devices, non-transitory mediums, and computer program products implemented as automated tools for identifying a plurality of parameters related to abnormalities in the skin of the subject.

The present disclosure relates to a system 100 for restoring the originality of the face by rejuvenating the skin texture by generating the new collagen in skin. The aspects/embodiment of the disclosure provides a system 100 for face lift and facial skin rejuvenation, which is a combination of facial contouring, skin tightening and volume restoration in an aging face.

According to an aspect of the present disclosure, FIG. 1 illustrates a system 100 for identifying the plurality of parameters comprising, a scanner 110 for scanning and capturing one or more feature points of the subject's skin from multiple angle and a remodeling processor (not shown) for constructing three-dimensional (3D) model of the subject's skin, a control unit 120 comprising a prediction processor for determining the fat loss in a desired location and predicting plurality of parameters based on the data obtained from the remodeling processor, one or more energy projecting systems 140 for directing plurality of parameters determined by the control unit 120, on the fat planes on the identified area of the subject's face.

In an embodiment of the present disclosure, the control unit 120 optionally controls or comprises a touch-screen panel 130 that allows a physician/user to interactively circumscribe the treatment area, to enter plurality of parameters of the rejuvenation process on the touch-screen panel 130 and to guide the physician/user to follow the path displayed on the touch-screen panel 130 for rejuvenation process. In an embodiment of the present disclosure, the system 100 works in an automatic manner where the control unit 120 predicts the plurality of parameters like temperature, pressure, intensity, and duration and sends the signal to the one or more energy projecting systems 140 to perform the treatment, without the intervention of users. In another embodiment of the present disclosure, the system 100 works in semi-automatic manner, where the control unit 120 predicts the plurality of parameters like temperature, pressure, intensity, and duration and sends the data to a touch-screen panel 130 that guides the user to interactively circumscribe the treatment area, to enter plurality of parameters of the rejuvenation process on the screen and to guide the physician/operator to follow the path displayed on the screen for repositioning.

In an embodiment of the present disclosure, the system 100 is configured to enhance an efficacy by iterative use of the system based on the plurality of parameters.

In an embodiment of the present disclosure, the first set of parameters and the second set of parameters corresponds to properties of a reference model and a test model of the subject respectively.

In an embodiment of the present disclosure, the remodeling system comprises an artificial intelligence (AI) algorithm for comparing a reference model with a test model for obtaining the plurality of parameters.

In an embodiment of the present disclosure, the reference model corresponds to a non-real-time model of the subject and the test model corresponds to a real-time-model of the subject.

In an embodiment of the present disclosure, the system 100 will grade the subject's face and adjusts the plurality of parameters accordingly. Generally, the system 100 grades the subject's face into 0-4 scale (i.e., grade 0-4), with reference to global drooping and wrinkle classification where there are no visible lines or sagging in grade 0. Grade 1 includes one or two fine wrinkles, and less than one third of the sagging of corresponding fat planes. Grade 2 includes more than two fine wrinkles and one third sagging. Further, grade 3 includes one to two deep wrinkles, two third sagging and grade 4 includes more than two deep wrinkles and complete sagging of facial areas divided into forehead, temples, malar area, periorbital hollowness or puffiness, nasolabial folds and jowls. Thus, total scoring of 7 areas based on sagging and 6 areas (periorbital area counted as one for wrinkle) based on wrinkles on face leads to total scoring between 0-52 and according to visible age estimation can be done (Garg. S., et. al.,¹). More specifically, if severity is very high (like grade 3 and 4) ageing in most of the areas below brows, the system 100 additionally suggests other sequential treatments like thread lift or facial fillers. The system 100 additionally suggests sequential botulinum toxin when the forehead is with dynamic or static wrinkles, heavy masseter etc.

In an exemplary embodiment of the present disclosure, the system 100 for identifying the plurality of parameters comprises four sub systems consisting of a scanner 110, a remodeling system, a prediction system, and an automatic moveable bed system for performing an system 100 for providing effective results by iterative use.

In an embodiment of the present disclosure, the system 100 comprises a scanner 110 for scanning and capturing one or more feature points of the subject's face from multiple angles, a remodeling processor for processing the digitally scanned data, restructure test models and compare the test model with reference models to find the alignment error and accuracy of the face model, a projector for referencing marker on the subject's skin, a control unit 120 comprising prediction processor for predicting the aging and for determining the plurality of parameters like temperature and pressure and sending the signals to perform the treatment, one or more energy projecting systems 140 for directing the plurality of parameters like heat energy at a predetermined temperature on the fat lobules on the identified area of the subject's face, a moveable robotic arm that is attached with the automatic movable bed system is coupled with the one or more energy projecting systems 140, one or more soft round and spherical like projection located at the tip of the robotic arm for re-positioning the heated fat lobules by applying controlled pressure in a specific direction without using any external agents.

In an embodiment of the present disclosure, the components of the system 100 of the present disclosure comprises a scanning system, a remodeling system, a prediction processor and an automatic moveable bed system. Further, the scanner 110 is related to the system 100 in which the face of the subject is scanned with the help of one or more optical sensing technology which converts 2-dimensional images into 3D model by using one or more facial scanning technologies which may include structured light scanning technology and other scanning technologies. The scanner 110 comprises a 3D scanner 110 (e.g., 3D advance scanner). The 3D scanner of the disclosure allows a user to measure and scan the subject virtually from multiple angles and directions to collect a large set of data which helps software to prepare test model and reference model of the face. The scanner 110 also adjusts the small movements in the subject and achieves results of superior precision and reliability, leading to a near perfect 3D face scan as an output. However, the scanner 110 is smaller in size and is integrated with advanced editing option to manipulate and resurfacing the facial fat planes in temporal, malar, and sub orbicular areas.

In an embodiment of the present disclosure, the scanner 110 is at least one selected from the group consisting of a camera, a video camera, a stereo photography 3dMD, a structured light facial scanner, a high-accuracy industrial line-laser scanner and other 3D scanners that are known in the art. In an embodiment, a pre-scanned image of the subject is uploaded to have a 3D analysis of the face of the subject based on global drooping and wrinkle classification.

In an embodiment of the present disclosure, an automated optical facial scanner to scan the face of the subject from multiple angles and direction to form a 3D face model with the help of a high-accuracy industrial line-laser scanner as the reference model and two test models are scanned via stereo photography 3dMD and a structured light facial scanner separately. Further, the output scanned active digital signal is transferred to the advanced cosmetics and plastic surgeries software as an input signal.

In an embodiment of the present disclosure, the system 100 comprises the remodeling system. The digitally scanned data from the scanner 110 is transferred to the remodeling system (which offers advance control solution in cosmetics and plastic surgeries) comprises a smart RDFP (reposing droopy fat planes) algorithm (otherwise known as Artificial Intelligence Algorithm) to restructure/reconstruct the test models and to compare the test models with the reference models to find the alignment error and practical accuracy of the face model. For example, the subject's photograph in youth is taken as standard reference image and accordingly deviations are delineated from that reference image. The advance program uses different standard deviation algorithm which finds the distance between the triangular points to reconstruct the facial fat planes. The advanced algorithm uses different statistical and mathematical expression to analyze the optical scanned images. The algorithm test includes Root Mean Square test, Standard Deviation test, K-S normality test, Paired T test, Tukey honestly, Dunnett's T3 post hoc tests and other algorithms that are well known in the art.

In another embodiment of the present disclosure, the remodeling system comprises a remodeling processor for processing the digitally scanned data and restructures the test models and compares the test model with reference models to find the alignment error and accuracy of the face model, wherein the subcutaneous face fat of the subject is further restructured or reconstructed with the help of a processor based on reverse engineering.

In an embodiment of the present disclosure, the system 100 comprises the prediction processor. The prediction processor is for predicting the aging or fat loss from a particular region of the subject's face and it also predicts the required plurality of parameters for the skin rejuvenation and face lift therapy. The plurality of parameters may include intensity of energy, temperature, pressure, angular motion, time duration for therapy, and number of sessions required for the therapy. For example, the subject's picture is uploaded in the system 100 and scored accordingly. The scoring is done by the processor by assessing the previously fed parameters-individual areas and overall visible aging is calculated. The processor then adjusts the treatment parameter like energy, duration, direction of wrinkles and so on. In a specific case, more severe changes require higher energy and longer duration direction wrinkles and deep folds addressed antigravity upwards, outwards and at 90 degrees of fold or deep wrinkle.

In an embodiment of the present disclosure, the automatic movable bed system comprises a stationary treatment console member, a movable robotics arm coupled with a camera, the one or more energy projecting systems 140 such as ultrasound for directing ultrasonic energy and radiofrequency to at least a portion of the identified treatment area of the skin to be treated and a projector for referencing marker on the skin.

In an embodiment of the present disclosure, the system 100 comprises a multi-directional self-movable robotic arm coupled with a high-resolution camera. The self-moveable robotic arm comprises an ultrasound transducer which emits a non-ionizing high-intensity focused ultrasound waves to heat adipose tissue present in the temporal, malar, and sub orbicular area of the subject. The heating improves the trans-membrane permeation of fatty acids in fat lobules and makes the fat more receptive to movement on pressure. The system 100 comprises an ultrasound head unit which is attached to the end of the movable arm having multiple degrees of freedom.

In an embodiment of the present disclosure, the one or more energy projecting systems 140 are at least one selected from the group consisting of a radio frequency (RF) device (e.g., radio frequency (RF) probe), an ultrasound device, and a laser device of a face mask with inbuilt probes. The one or more energy projecting systems 140 comprises multiple probes placed on the distal end of the system 100 where the one or more energy projecting systems 140 are controlled by the control unit 120 of the system 100 to apply heat and pressure on the subcutaneous fat of the facial skin at a predetermined temperature, the heating improves trans-membrane permeation of fatty acids in fat lobules and makes the fat more receptive to movement on pressure. The system 100 involves re-positioning the heated fat lobules by applying pressure through probe towards temporal, malar and sub-orbicular areas and thereby filling the hollowed and flattened areas of the face by the mobilized fat without using any external fillers or skin modifying agents. The one or more energy projecting systems 140 of the present disclosure is embedded with either manually operated hand-held devices or configured in the fully automated robotic system which applies pressure and heat over the facial skin and underlying tissues to move fat over the face planes.

In an embodiment, the face mask is inbuilt with probes specific for various fat planes that are used as an energy projecting system.

In an embodiment of the present disclosure, the system 100 further comprises one or more soft round and spherical like projection located at the tip of the robotic arm for re-positioning the heated fat lobules by applying controlled pressure at 35-40 mm Hg by placing an encircling jawline to head strap which pushes the facial tissue away from midface and define the v line of jaw. In other words, the self-moveable robotic arm further comprises one or more soft round and spherical like projection at the tip of the arm which is synchronized with ultrasound transducer to re-position the heated fat lobules by applying controlled pressure. The parallel force generated by one or more projections helps to fill the hollow and flatten areas of the face by the mobilized fat without using any external agents.

In an embodiment of the present disclosure, the control unit 120 optionally comprises a touch-screen panel 130 which allows a physician (or the operator of the system 100) to interactively circumscribe the treatment area, to enter plurality of parameters for rejuvenation on the screen and to guide the physician/operator to follow the path displayed on the screen for repositioning.

In an embodiment of the present disclosure, the system 100 discloses rejuvenation of the facial fat. The system 100 comprising a high-resolution camera and/or 3D scanner 110 which take multiple pictures of the subject's face from different angles to develop a 3D face of the subject. The 3D scanning of the human face is achieved by obtaining two-dimensional (2D) face image for reconstructing features point which represents the human face contour. The scanner 110 further includes determining all possible points on the subject's face based on one or more fat planes. The algorithm of the system 100 adjusts or reconstructs the specific points in a computer with the texture mapping to obtain a preliminary test model of the subject face.

In an embodiment, a 3D scan is made up of small triangles, or polygons which are similar to the pixel of 2D pictures. The numbers of polygons are combined to produce a polygonal mesh, which accurately mimics the geometry of the object. In the present disclosure the 3D facial structure is created via a 3D scanner 110 but not limited to camera, laser technology, video camera etc. The scanner 110 captures the geometry and circumference of an object surface and converts the images into a 3D model rather than a 2D image.

In an embodiment, the preliminary test model created by the system 100 allows the technician/physician/operator to visualize the rejuvenated face model of the subject and measure the scanning accuracy to determine the error in scanning process. The supervised learning of the software predicts the face of the subject after rejuvenation and allows the technician to restructure the face based on any deformities before the rejuvenation process starts. In an embodiment, the software also makes use of photographs of same person from younger age group and customize the face lift process based on present deformities on the face. The system 100 detects various feature points related to eyebrows, eyes, nose, mouth, chin and both cheeks on a human face. The one or more feature points of the subject are determined in both automatic manner (e.g., semi-automatic manner) and manual manner. In the automatic manner, the program is coded based on machine learning algorithms where the coordinates are arranged on the face automatically with the help of trained algorithm. In the manual optimization, the technician may also adjust the pointers and re-frame the fat lobules manually based on best possible outcomes.

In an embodiment, the system 100 allows the user to restructure or re-model the facial fat planes. After the scanning part is completed, the digitally scanned data is transferred to the remodeling system as an input data. The remodeling system which further includes a smart algorithm, restructure the test models to reference models to find the alignment error and practical accuracy of the face model. The remodeling system detects the age of the subject and uses one or more algorithm to redesign the fat structure on the reference of the scanned data and previous photographs of the subject. The advance program of triangulation system of the optical sensing technology uses different standard deviation algorithm which finds the distance between the triangular points to reconstruct the facial fat planes. The advanced algorithm may use different statistical and mathematical test to analyze the optical scanned images wherein the test of the algorithm includes Root Mean Square Test, Standard Deviation Test, K-S Normality Test, Paired T Test, Tukey Honestly and Dunnett's T3 Post Hoc Tests etc.

In an embodiment of the present disclosure, the smart integrated AI-based system discloses an algorithm based on supervised learning where the accuracy and precision of the system 100 improves automatically through experience by using data. The algorithm of the system utilizes sample data or training data to minimize the error percentage while scanning and reconstructing the face for anti-aging features. The three main objectives of the AI-based system are: A) to scan the 3D face model of the subject with the help of optical scanning technology by eliminating noise data and large scanning errors. B) to develop the test model of the subject with the reference data collected from the scanner 110. The process of scanning and developing the test model is conducted multiple times to purify the data and reserved overlapping regions of the faces. C) to calculate the plurality of parameters required for facial fat rejuvenation. The calculated data is transmitted by the control unit 120 to the one or more energy projecting systems 140 which are either connected to hand-held RF device or an automatic robotic system.

In an embodiment of the present disclosure, the one or more energy projecting systems 140 are either embedded with the hand-held probe device or attached to the distal end of automatic robotic system.

In an embodiment of the present disclosure, the hand-held probe device, the predicted/calculated data from the prediction processor guides the technician to select the intensity and magnitude of the energy related to particular area. The system splits-up the different regions of the face in multiple segments or plane, also each segment/plane is categorized on the basis of fat deposition and volume. In an embodiment, the AI-based system suggests technician to apply pre-calculated energy and direct the technician to follow the specific path or angle to achieve the remodeling of the face as previously designed in computerized test model. Firstly, the technician chooses the different segments of the faces manually on the touch-screen panel 130 and the system 100 automatically adjusts to certain threshold value for RF energy and guides the technician to follow the path or direction as displayed on the screen of the control panel.

In another embodiment of the present disclosure, the one or more energy projecting systems 140 are also configured with the automatic robotic system, wherein the one or more manipulator members of the robotic system comprises of plurality of probes which apply pressure through a soft round like projection towards temporal, malar and sub-orbicular areas and thereby filling the hollowed and flattened areas of the face by the mobilized fat without using any external fillers or skin modifying agents. Finally, the robotic arms are used to apply the pressure over the facial skin and underlying tissues of the face which restore the fat planes over desired flattened compartments and hollowed areas. The automated robotic system comprises two or more arms having variable length and joints. The two or more arms of the system are freely movable and have more than four degrees of rotation with multiple links and motors for the precise movement and rotation. Depending upon input signal of the facial design, the robotic system is equipped with various sensors, which detect and control the pre-defined instructions of the user and convert the digital signal into corresponding control signals. The automatic robotic system is in communication with AI-based smart system which continuously commands the robotic arms to move in different planes of the face to apply pressure and energy in a definite orientation.

In an embodiment of the present disclosure, the system 100 uses propagated wave energy to heat the facial skin. Heat is applied to effect neocollagenesis, collagen remodeling, skin tightening and thereby achieving the face lift and volume restoration of the face. However, the heating is done at a temperature such that it neither burns the skin nor does it destroy the collagen matrix and the fat layers with temperature monitor on the touch-screen panel 130.

In another embodiment of the present disclosure, the system for providing wave energy to reshape the facial fats includes radio waves or acoustic wave energy. The energy deployed from the probes are used for reshaping face fat by altering position of the fat in the facial area.

In another embodiment of the present disclosure, the hand-held probe device is an RF probe to heat the facial skin, where the heat is applied to affect neocollagenesis, collagen remodeling, skin tightening and thereby achieving the face lift and volume restoration of the face. Radio energy with non-ablative electrodes is used to heat the subcutaneous fat such that it leads to neocollagenesis by fibroblasts activation and liquefies the fat disposed in redundant fat planes. However, the heating is done at a temperature such that it neither burns the skin nor does it destroy the collagen matrix and the fat layers. Along with the heating, pressure is also applied by the RF probe thereby pushing the fat against the tracts of descent of fat planes due to aging. The applicator probe in its forward stroke is used to apply pressure in upwards and outwards in antigravity mode while moving against the tract of decent and no pressure is applied in its back stroke while moving along the fat plane decent. The heat and the applied pressure cause fat permeation across fat septae membranes to re-position the migrated fat planes of face back on their original places.

The physical pressure not only helps to push fat along the desired compartments but also loosens the ties between the fat cells thereby aiding the release of liquefied fat from the fat cells. Once fat gets liquefied it is possible to mobilize these liquefied fat planes to original compartments respecting their tracts of descend. Since the skin and fat planes are interconnected and traversed by fibrous septae, migration of one plane helps in pulling the adjoining plane and thus improving the volume over desired sites.

In an embodiment of the present disclosure, the RF probe is selected from monopolar probe. In an exemplary embodiment of the disclosure, the RF probe is deployed upon the subject's facial skin and pressure is applied with monopolar electrodes to push the fat in a direction opposite to the descent of fat planes. In a preferred embodiment, the pressure is applied in its forward stroke in upwards and outwards direction in antigravity mode while moving against the tract of decent and no pressure in its back stroke while moving along the fat plane decent. In an embodiment, the one or more energy projecting systems 140 (i.e., RF probe) delivers the energy to raise the surface temperature to 40-42° C. for approximately 4 to 5 minutes for each treated region. In another embodiment, the one or more energy projecting systems 140 directs energy to the subject's skin to gradually increase the temperature till 40 degrees for 1 minute and followed by persistent heating at around 40 Celsius for next 3 minutes.

The system additionally has cooling mechanism which is adjusted as required to allow targeting of skin or subcutaneous tissue. With this system specific skin laxity or contour deformities is given focused heating by controlling the depth of penetration together with controlled cooling. The monopolar probe may be used in static or dynamic mode to deliver the radio frequency as required. In the static mode, a single pulse is delivered at the first area and after that, the hand probe is moved to the next treatment area and pulse is transmitted again. With dynamic monopolar, the hand probe is continuously moved along specific treatment areas to deliver the required amount of thermal effect.

Along with the heating, pressure is also applied by the distal end of the RF probe system thereby pushing the fat against the tracts of descent of fat planes due to aging. The applicator probe present at distal end of the RF Probe system is used to apply pressure in upwards and outwards in antigravity mode while moving against the tract of decent and no pressure is applied in its back stroke while moving along the fat plane decent. The heat and the applied pressure cause fat permeation across fat septae membranes to re-position the migrated fat planes of face back on their original places. The rise in temperature due to heating leads to increase in the metabolism of the fat cells and secretion of fatty acids (liquid fat) aiding their easy migration along the desired plane. Also, heating the subcutaneous tissue can stimulate and renew the skin's collagen and ultimately improve the texture and reduce the sagging of the skin.

The above-formulated principle is mainly selected from two promising techniques which provides an energy with non-ablative elements such as RF probes and/or High intensity focused ultrasound (HIFU). The RF probes are used to heat the subcutaneous fat such that it leads to neocollagenesis by fibroblasts activation and liquefies the fat disposed in redundant fat planes.

In an embodiment of the present disclosure, the system 100 of identifying the plurality of parameters includes radio frequency lipolysis wherein the facial skin of the subject is preheated at 30-40° C. for 1-3 minutes before applying the pressure by RF probe. The temperature is gradually increased till 40 degrees Celsius using the RF probe for 1-2 minutes, followed by persistent heating at 40 Celsius for the next 3 minutes. The heating makes fat lobules more permeable and flexible to push these compartments by firm and graded pressure along the tracts of drooping of fat planes. The cheek region on each side of the face is heated for 4 minutes. The heating makes the fat lobules more permeable and flexible, but the heating should not cause heat related necrosis of the skin fat (which is attained at more than 43 degrees Celsius with persistent heating for 6 to 10 minutes). This procedure helps in the movement of fat compartments through radiofrequency probe to attain filling effect on desired areas.

In an embodiment of the present disclosure, the plurality of parameters are as follows, energy—70-90 J, surface temperature—37-38 degree Celsius, pressure—35-40 mm Hg upwards and outwards directed 90 degrees to direction of mesomental and nasolabial folds, time duration 3-4 minutes depending on less or more severe changes and angle of probe—45 degree from surface of skin on cheeks.

In an embodiment of the present disclosure, the controlled RF beams can prevent skin burn by avoiding long time exposure towards the same skin area. The time cost could be significantly reduced, as there is no need to interrupt the rejuvenation procedure for cooling the skin. In addition, the proposed robotic control strategies are more accurate and save more time as compared to conventional process.

In an embodiment of the present disclosure, the energy of the one or more energy projecting systems 140 refers to the stimulation of skin or other body tissue with any type of energy including, but not limited to, heat energy, radiant, electromagnetic radiation (EMR), electromagnetic pulses, electrical currents, infrared, visible light, ultraviolet, magnetic waves, sonic, ultrasonic, and others that are known in the art.

In an embodiment of the present disclosure, the subject is an individual.

In an embodiment of the present disclosure, the system 100 is applicable to both clinical setting and/or house-based settings.

In an embodiment of the present disclosure, the system 100 for identifying the plurality of parameters related to abnormalities of the subject's skin is not limited to facial rejuvenation, but also for other body parts like neck, chin, hand, legs, abdomen, and other various body parts.

In an embodiment of the present disclosure, the system 100 suggests plurality of parameters related to abnormalities in the subject's skin, and thereby helps in suggesting treatment process as a single stage process. In another embodiment of the present disclosure, the system 100 suggests treatment process as multiple stage process, where the subject is checked for the effectiveness and further treated for several times using the system 100 of the present disclosure. In yet another embodiment of the present disclosure, the system 100 helps in suggesting treatment based on the subsequent treatment time (next session) predicted by the prediction processor.

In an embodiment of the present disclosure, the movable robotic arm works automatically with the help of control unit 120. In another embodiment of the present disclosure, the movable robotic arm is controlled manually by a physician or a trained person.

The system 100 of the present disclosure is illustrated in detail with reference to examples, but the present disclosure should not be interpreted as being restricted thereto.

### EXAMPLE 1

The study listed below for this example was conducted with manual approaches by excluding any automation and AI-based system disclosed in the present disclosure can be used as a reference data set to feed into an AI-based system that uses these data sets in the back-end process to help the system 100 restructure the facial fat distribution more precisely and provide all possible outcomes on the screen before the rejuvenation process begins. Thirty subjects between the age group of 25 to 65 years of age are selected who were willing to undergo the treatment as per the disclosure. (Table.1: Shows the number of subjects in respective age groups)

TABLE 1

| Age group (years) | Number of subjects |
|---|---|
| 25 to 35 | 10 |
| 36 to 45 | 7 |
| 46 to 55 | 9 |
| >56 | 4 |

All the thirty subjects are classified as per suggested DW classification based on presence of drooping and wrinkles on different areas of face. Accordingly, in temporal loss of fat (T1, T2, T3, T4), malar loss of fat (M1, M2, M3, M4), periorbital puffiness (P1, P2, P3, P4), periorbital hollowness (H1, H2, H3, H4), nasolabial (N1, N2, N3, N4), wrinkles (W1, W2, W3, W4) and Jowl (J1, J2, J3, J4) for slight, mild, moderate and severe changes respectively.

Based on the above mentioned DW classification the initial (before therapy) facial prominences classification as shown in tables 2a and 2b which explain the prominences final (after therapy) classification. Both the tables 2a and 2b show the loss of volume with respect to the corresponding wrinkles in the temporal and malar regions, the hollowness (H) or puffiness (P) with respect to the corresponding wrinkles in the orbital region, the drooping with respect to the corresponding wrinkles in the jowl region and the prominence of the nasolabial fold with respect to the corresponding wrinkles before and after the therapy respectively.

TABLE 2a
Initial Classification (Before Therapy)

| | | Tear | | | |
|---|---|---|---|---|---|
| | | Trough | | | |
| | | Depth | | | |
| | Temporal | (Hollowness | Jowl | N.L Fold | Malar |
| | Fat(Loss of | H/Puffiness | (Drooping/ | (Priminence/ | Fat(Loss of |
| Age | Volume/Wrinkle) | P/Wrinkle) | Wrinkle) | Wrinkle) | Volume/Wrinkle) |
| 26 | T1W1 | H1W1 | J1W0 | N1W0 | M1W0 |
| 27 | T2W1 | H1W1 | J1W1 | N2W1 | M2W1 |
| 27 | T3W1 | P3W3 | J1W0 | N3W2 | M3W2 |
| 28 | T1W1 | H2W1 | J0W0 | N1W0 | M1W0 |
| 30 | T2W1 | HIW1 | J1W1 | N2W1 | M1W1 |
| 32 | T3W1 | H2W1 | J1W1 | N2W1 | M4W1 |
| 32 | T3W1 | H2W1 | J3W1 | N3W1 | M2W1 |
| 33 | T3W2 | H4W3 | J2W1 | N4W2 | M2W2 |
| 33 | T3W1 | H2W2 | J4W1 | N4W1 | M3W1 |
| 35 | T2W1 | H3W2 | J2W1 | N3W1 | M3W1 |
| 37 | T3W2 | H3W3 | J2W1 | N3W1 | M3W2 |
| 38 | T4W2 | H3W2 | J3W2 | N4W2 | M3W1 |
| 39 | T4W3 | H4W2 | J3W1 | N3W1 | M3W2 |
| 40 | T3W1 | H3W2 | J2W1 | N2W1 | M2W1 |
| 42 | T3W2 | P3W2 | J2W2 | N4W2 | M3W1 |
| 42 | T2W2 | P3W2 | J2W1 | N3W1 | M1W0 |
| 43 | T3 W3 | P4W3 | J3W1 | N3W1 | M3W2 |
| 47 | T3W2 | H4W2 | J3W2 | N4W2 | M2W2 |
| 47 | T4W2 | P4W2 | J3W1 | N3W1 | M4W1 |
| 47 | T4 W4 | H4W4 | J4W3 | N4W3 | M3W4 |
| 49 | T3W2 | P4W2 | J3W2 | N3W2 | M2W1 |
| 51 | T4W2 | H3W2 | J2W2 | N3W2 | M3W2 |
| 52 | T4W3 | P4W4 | J3W3 | N4W2 | M4W2 |
| 52 | T4W2 | H4W2 | J4W2 | N4W1 | M4W2 |
| 52 | T4 W4 | H3W4 | J2W3 | N4W2 | M4W4 |
| 53 | T3 W3 | H3W4 | J3W3 | N3W2 | M3W3 |
| 57 | T3W2 | P3W3 | J3W2 | N3W1 | M2W1 |
| 59 | T4W4 | H4W4 | J4W4 | N4W4 | M4W4 |
| 64 | T3W2 | H4W4 | J4W2 | N4W2 | M3W2 |
| 65 | T2W1 | H2W1 | J4W1 | N4W1 | M2W1 |

TABLE 2b
Final Classification (After Therapy)

| | | Tear | | | |
|---|---|---|---|---|---|
| | | Trough | | | |
| | Temporal | Depth(Hollowness | Jowl | N.L | Malar |
| | Fat(Loss of | H/Puffiness | (Drooping/ | Fold(Drooping | Fat(Loss of |
| Age | Volume/Wrinkle) | P/Wrinkle) | Wrinkle) | Wrinkle) | Volume/Wrinkle) |
| 26 | T0W0 | H1W0 | J0W0 | N0W0 | M1W0 |
| 27 | T1W0 | H1W0 | J1W0 | N1W0 | M1W0 |
| 27 | T2W1 | P2W1 | J1W0 | N2W1 | M2W1 |
| 28 | T0W0 | H1W1 | J0W0 | N0W0 | M0W0 |
| 30 | T1W1 | H1W1 | J1W1 | N1W1 | M1W1 |
| 32 | T1W0 | H0W0 | J1W0 | N1W0 | M1W0 |
| 32 | T2W1 | H1W1 | J2W1 | N2W1 | M1W1 |
| 33 | T2W1 | H2W2 | J1W1 | N2W1 | M1W1 |
| 33 | T2W1 | H1W1 | J2W1 | N3W1 | M1W1 |
| 35 | T1W1 | H2W1 | J1W1 | N2W1 | M1W1 |
| 37 | T1W1 | H2W1 | J1W1 | N1W1 | M1W1 |
| 38 | T2W1 | H1W1 | J1W1 | N2W1 | M2W1 |
| 39 | T2W1 | H3W1 | J2W1 | N2W1 | M2W1 |
| 40 | T2W1 | H2W1 | J1W1 | N1W1 | M1W1 |
| 42 | T1W1 | H1W1 | J1W1 | N2W1 | M2W1 |
| 42 | T1W1 | P1W2 | J1W0 | N1W0 | M1W1 |
| 43 | T1W1 | P1W2 | J2W1 | N2W1 | M1W1 |
| 47 | T2W1 | H2W1 | J1W1 | N2W1 | M1W1 |
| 47 | T2W1 | P2W1 | J1W1 | N2W1 | M2W1 |
| 47 | T3W2 | H3W3 | J2W1 | N3W1 | M2W1 |
| 49 | T2W1 | P2W2 | J2W1 | N2W1 | M1W1 |
| 51 | T2W1 | H2W1 | J1W1 | N2W1 | M1W1 |
| 52 | T2W2 | P2W1 | J1W1 | N3W1 | M2W1 |
| 52 | T2W1 | H3W1 | J2W1 | N3W1 | M2W1 |
| 52 | T3W3 | H1W3 | J1W1 | N3W2 | M2W3 |
| 53 | T2W1 | H2W2 | J1W2 | N1W1 | M1W1 |
| 57 | T2W1 | P1W2 | J2W1 | N2W1 | M1W1 |
| 59 | T2W3 | H2W3 | J2W2 | N2W2 | M2W2 |
| 64 | T2W1 | H2W2 | J3W1 | N3W1 | M2W1 |
| 65 | T1W1 | H1W1 | J3W1 | N3W1 | M2W1 |

Table 3a: shows the severity-ranking of the temporal fat loss of volume with respect to the corresponding wrinkles:

| | | | |
|---|---|---|---|
| Stage 1 | slight | T1-less than ⅓ volume loss area | W1-less than |
| | | outside orbital rim from vertical | 2 fine lines |
| | | line from orbital rim to temporal | |
| | | bone | |
| Stage 2 | mild | T2-⅓ volume loss in area outside | W2-more |
| | | orbital rim from vertical line | than 2 fi lines |
| | | joining orbital rim and temporal | |
| | | bone | |
| Stage 3 | moderate | T3-less than ⅔ volume loss | W3-less than |
| | | | 2 deep lines |
| Stage4 | severe | T4- more than ⅔ volume loss | W4-more |
| | | | than 2 deep |
| | | | lines |

Table 3b: shows the severity-ranking of the hollowness (H) or puffiness (P) with respect to the corresponding wrinkles in the orbital region. (w follows same scale in every area as mentioned above)

| | | | |
|---|---|---|---|
| Stage 1 | slight | H1/P1- less than ⅓ medial side | W1 |
| | | of infraorbital area | |
| Stage 2 | mild | H2/P2- ⅓ infra-orbital area | W2 |
| Stage 3 | moderate | H3/P3- ⅔ of infra-orbital area | W3 |
| Stage4 | severe | H4/P4- whole infra-orbital area involved | W4 |

Table 3c: shows the severity-ranking of the malar fat loss of volume with respect to the corresponding wrinkles.

| | | | |
|---|---|---|---|
| Stage 1 | slight | M1-some flattening but no nasojugal groove | W1 |
| Stage 2 | mild | M2- Mild flattening with less than ⅓ of | W2 |
| | | nasojugal groove stating from infra-orbital | |
| | | rim to zygoma | |
| Stage 3 | moderate | M3- moderate flattening with less than ⅔ of | W3 |
| | | nasojugal groove | |
| Stage4 | severe | M4-severe flattening with more than ⅔ | W4 |
| | | prominence | |

Table 3d: shows the severity-ranking of the drooping with respect to the corresponding wrinkles in the jowl region.

| | | | |
|---|---|---|---|
| Stage 1 | slight | J1- ⅓ of mesomental fold | W1 |
| Stage 2 | mild | J2-upto ⅔ of mesomental fold | W2 |
| Stage 3 | moderate | J3 -complete mesomental fold but no | W3 |
| | | drooping below jaw | |
| Stage4 | severe | J4-complete mesomental fold with | W4 |
| | | drooping of jowl below jawline | |

Table 3e: shows the severity-ranking of the nasolabial fold with respect to the corresponding wrinkles before and after the therapy respectively.

| | | | |
|---|---|---|---|
| Stage 1 | slight | N1- less than upper ⅓ of | W1 |
| | | Nasolabial fold | |
| Stage 2 | mild | N2- ⅔ of Nasolabial fold | W2 |
| Stage 3 | moderate | N3-complete Nasolabial fold | W3 |
| Stage4 | severe | N4- complete Nasolabial fold in | W4 |
| | | continuation with mesomental fold | |

### Results

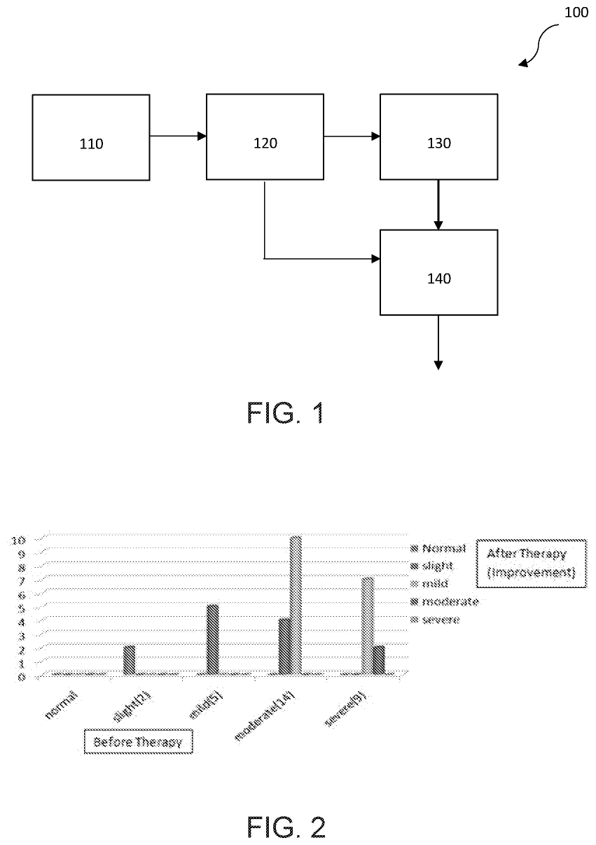

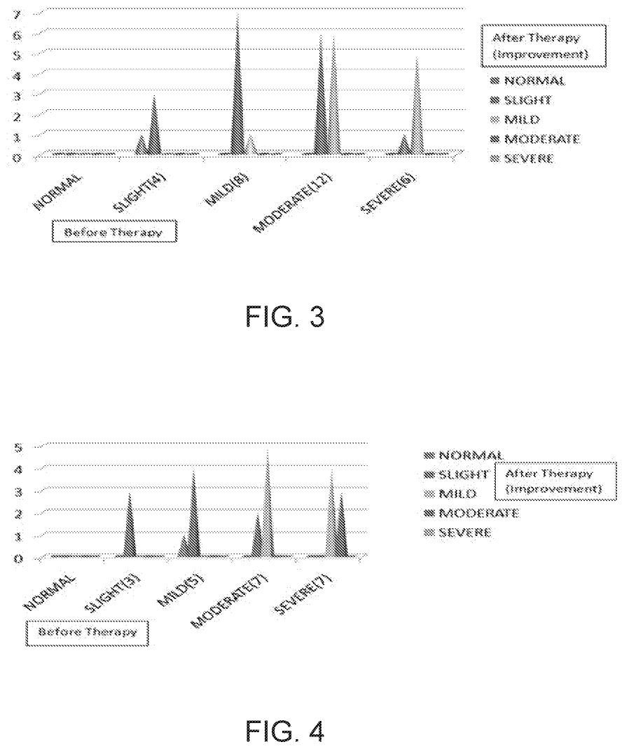

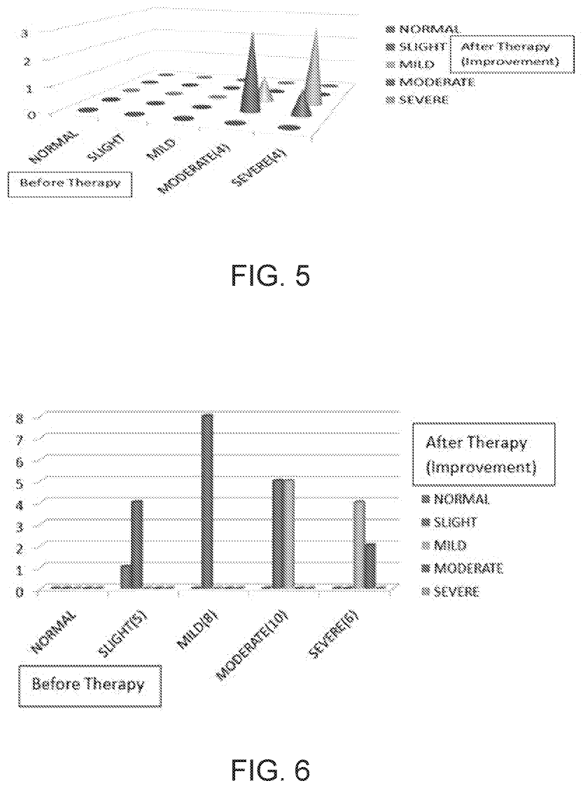

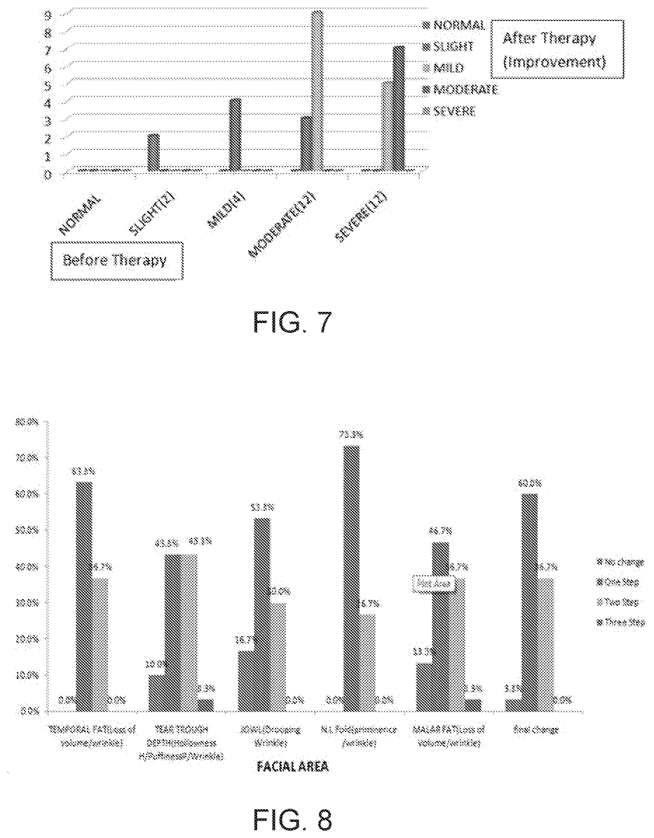

Out of 30 subjects, there were 24 females and 6 males in the study. There were 10 subjects in between 25 to 35 years age group, 7 in 36 to 45 years, 9 in 45 to 55 years and 4 in the more than 55 years age group. FIG. 2 shows that severe loss of temporal fat (grade 4) was evident in 9 subjects, out of which 7 improved to mild (grade 2) and 2 improved to moderate (grade 3) with p value as highly significant. The malar fat volume as shown in FIG. 3 improved by 2 grades in 5 out of 6 subjects with severe grade 4 changes. The periorbital aging as grade 4 hollowness were seen in 7 subjects who improved to grade 2 in 4 and grade 3 in 3 subjects as shown in FIG. 4. The puffiness as shown in FIG. 5 improved by 2 grades in 3 out of 4 subjects showing severe grade 4 changes. Both changes were statistically significant, but hollowness responded better as compared to puffiness on statistical comparison. Severe jowl changes as depicted in FIG. 6 where 6 subjects improved by two grades in 4 subjects and severe nasolabial changes as shown in FIG. 7 where 12 subjects improved by two grades in 5 subjects. FIG. 8 and Table 4 shows the overall outcome for all the areas, hollow eyes improved the best by also showing three step improvements followed by malar area. Deep set grade 4 wrinkles in 6 subjects improved in number and depth by two grades in 3 and one grade in another 3 subjects. Out of 10 subjects showing many fine wrinkles, 7 improved to one to two fine wrinkles category. One step improvement shown 10 years age reversal, two step 20 years, and three step thirty years, age reversal based on drooping and wrinkle classification shown in Table 4.

TABLE 4

| Facial Area | No change | One Step | Two Step | Three Step |
|---|---|---|---|---|
| Temporal Fat (Loss of | 0.0% | 63.3% | 36.7% | 0.0% |
| Volume/Wrinkle) | | | | |
| Tear Trough Depth | 10.0% | 43.3% | 43.3% | 3.3% |
| (Hollowness | | | | |
| H/Puffiness P/ | | | | |
| Wrinkle) | | | | |
| Jowl (Drooping | 16.7% | 53.3% | 30.0% | 0.0% |
| Wrinkle) | | | | |
| Nasolabial Fold | 0.0% | 73.3% | 26.7% | 0.0% |
| (Prominence/ | | | | |
| Wrinkle) | | | | |
| Malar Fat (Loss of | 13.3% | 46.7% | 36.7% | 3.3% |
| Volume/Wrinkle) | | | | |
| Final Change | 3.3% | 60.0% | 36.7% | 0.0% |

Besides the statistical evaluation of the changes based on the clinical classification, two more relevant procedures were carried out to ensure the change in volume. For this, two subjects were subjected to VECTRA H1 system for change in volume over different facial areas and two other subjects were randomly assessed by ultrasound for change in depth of subcutaneous fat, before and after the procedure.

The VECTRA H1 handheld imaging system was used to analyze the efficacy of the procedure of the present disclosure. VECTRA H1 provides automatic volume difference measurement along with visual contour change mapping.

For the first subject the VECTRA H1 system showed a change of 5.163 cc of volume in marked area and a change of 3.892 cc of volume in marked area after the therapy.

For the second subject the VECTRA H1 system showed a change of 0.717 cc of volume in marked area and a change of 1.199 cc of volume in marked area after the therapy.

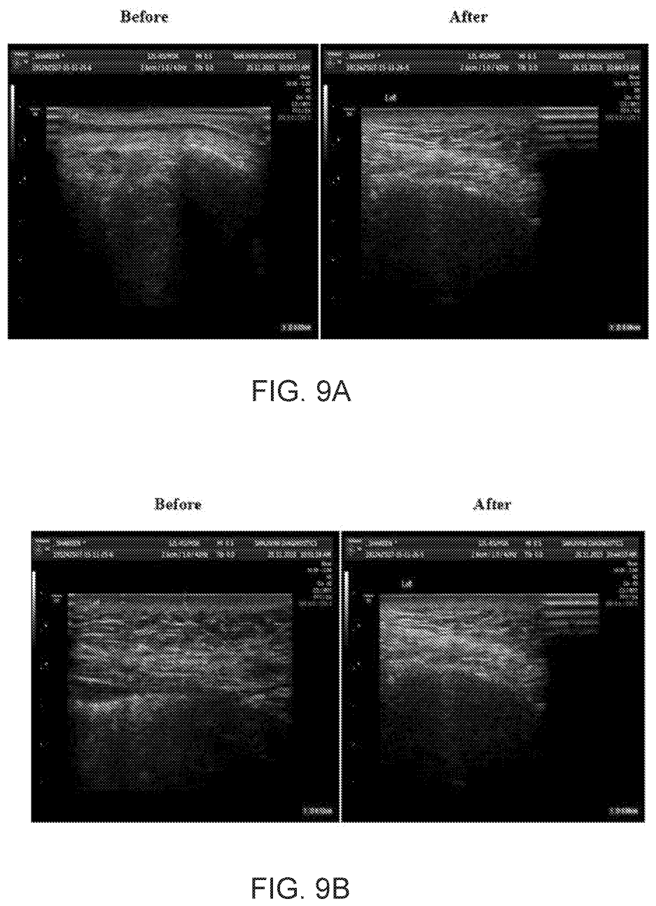

Further, the FIG. 9A shows an ultrasound of the medial side of periorbital area changed to 0.05 cm as compared to the initial value of 0.03 cm before the therapy (shifting of redundant fat towards eye) and FIG. 9B shows the ultrasound of the nasolabial fold depth till fat layer changed to 0.08 cm as compared to the initial value of 0.12 cm before the therapy (shift from nasolabial folds towards eyes and malar area).

Therefore, the system 100 of the present disclosure is useful not only in skin tightening but very effective facial contour re-positions and face volume restoration by restoring the fat planes over desired flattened contours and hollowed areas due to aging process.

To further summarize the disclosure, the system 100 for identifying the plurality of parameters related to abnormalities in the subject's skin comprises a scanner 110, a remodeling system, and a predictive system, where the scanning of subject's face is done by rotating camera, or a pre-scanned image uploaded to have a 3D analysis of the face followed by estimating the present age and enter the required/target new age and accessing the requirement of different fat planes to gauge the energy parameters to be applied. The remodeling system comprises the step of applying multi-probe energy system using the one or more energy projecting systems 140 (i.e., probe), wherein each probe is controlled by specific controllers to execute the required energy and motion. The multiprobe system can be a robotic arm with various probes or a face mask with inbuilt probes specific for various fat planes. Further, re-assessing the requirements during the procedure based on the various sensors to ascertain the effect of the protocol and applying gradual cooling effect using the probes/mask to hold the fat planes in new positions. Then, the predictive system comprises a processor for predicting the aging and calculating the time for subsequent therapy based on time/energy requirements of the process and accessing the skin response.

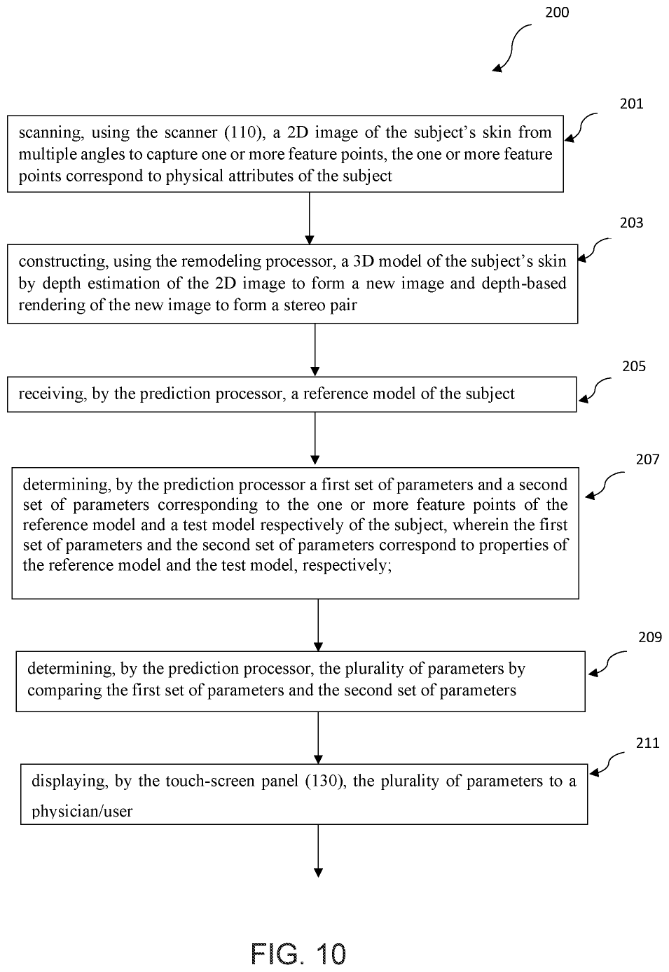

FIG. 10 illustrates an exemplary flowchart illustrating a method 200 for identifying a plurality of parameters related to abnormalities in a subject's skin in accordance with the present disclosure. The method 200 is configured to be performed by using the system 100 as described in FIG. 1. Accordingly, all the components of the system 100 may be included hereinbelow for performing the method 200. In that, the system 100 comprises a scanner 110, a remodeling processor, a control unit 120, a prediction processor, a touch-screen panel 130 and one or more energy projecting systems 140.

The method 200 starts with step 201, in which the method 200 comprises the step of scanning using the scanner 110, a 2D image of the subject's skin from multiple angles to capture one or more feature points. The one or more feature points corresponds to physical attributes of the subject. The subject's skin may be the neck, the chin, hands, legs, the abdomen, and other body parts of the subject.

In step 203, the method 200 comprise the step of constructing a 3D model of the subject's skin using the remodeling processor. The 3D model of the subject's skin is constructed by depth estimation of the 2D image to for a new image. Further, the new image is modified by depth-based rendering to form a stereo pair.

In step 205, the method 200 comprise the step of receiving a reference model of the subject's skin by the prediction processor. The reference model is based on a non-real-time model of the subject's skin.

In step 207, the method 200 comprise the step of determining by the prediction processor, a first set of parameters and a second set of parameters. The first set of parameters and the second set of parameters corresponds to the one or more feature points of the reference model and a test model respectively of the subject's skin. Further, the first set of parameters and the second set of parameters correspond to properties of the reference model and the test model respectively.

In step 209, the method 200 includes the step of determining the plurality of parameters by the prediction processor. The plurality of parameters are determined by comparing the first set of parameters and the second set of parameters. The plurality of parameters are selected from the group consisting of magnitude and intensity of energy and pressure, temperature, degree angle for movement of probe, time duration, number of repetitions of the procedure, number of sessions and combinations thereof.

In step 211, the method 200 comprises the step of displaying by the touch-screen panel 130, the plurality of parameters to a physician/user. The touch-screen panel 130 displays the ongoing plurality of parameters like the temperature, the pressure, and the treatment area.

In an embodiment of the present disclosure, the method 200 comprises iteratively using the system 100 for treating the treatment area of the subject's skin to achieve optimal skin rejuvenation and face lifting.

In an embodiment of the present disclosure, the method 200 comprises one or more energy projecting systems 140 configured for directing the plurality of parameters suggested by the touch-screen panel 130 on the fat planes that are identified on the subject's skin.

In an embodiment of the present disclosure, the method 200 comprises the step of determining by the remodeling system the plurality of parameters using one or more artificial intelligence (AI) techniques.

In an embodiment of the present disclosure, the method 200 includes adjusting the plurality of parameters of the one or more energy projecting systems 140, the plurality of parameters are selected from a group consisting of temperature, pressure, time duration, magnitude and intensity of energy applied, angular motion, direction of movement and combinations thereof.

Thus, the advantages of the present disclosure including but not limited to are a novel, system 100 based on regenerative corrective therapy, since it is non-surgical and utilizes body's existing fat for facial rejuvenation, thereby avoiding the usage of external fillers and toxic substances. The system 100 suggests a non-surgical treatment, so it avoids incisions and cuts, thereby no bleeding or skin damage. Moreover, the post-operative recovery period is hardly few minutes, without downtime, and the procedure is also not very expensive. In general, it does not involve the cutting of muscle or extensive dermal tissue with no risk of foreign body reaction, vascular complications, or infection.

Although the present disclosure has been described in terms of certain preferred embodiments, various features of separate embodiments can be combined to form additional embodiments not expressly described. Moreover, other embodiments apparent to those of ordinary skill in the art after reading this disclosure are also within the scope of this disclosure. Furthermore, not all of the features, aspects and advantages are necessarily required to practice the present disclosure. Thus, while the above detailed description has shown, described, and pointed out novel features of the disclosure as applied to various embodiments, it will be understood that various omissions, substitutions, and changes in the form and details of the apparatus or process illustrated may be made by those of ordinary skill in the technology without departing from the spirit of the disclosure. The disclosures may be embodied in other specific forms not explicitly described herein. The embodiments described above are to be considered in all respects as illustrative only and not restrictive in any manner. Aspects disclosed herein include:

A. A system of identifying a plurality of parameters related to abnormalities in a subject's skin, the system including: 1) a scanner configured to scan a 2D image of the subject's skin from multiple angles to capture one or more feature points, the one or more feature points correspond to physical attributes of the subject; 2) a remodeling processor configured to construct a 3D model of the subject's skin by depth estimation of the 2D image to form a new image and depth-based rendering of the new image to form a stereo pair; 3) a control unit comprising a prediction processor, the prediction processor configured to determine a first set of parameters and a second set of parameters corresponding to the one or more feature points; and 4) a touch-screen panel configured to display the plurality of parameters to a physician/user, wherein the plurality of parameters are determined by the prediction processor using the first set of parameters and the second set of parameters.

B. A method of identifying a plurality of parameters related to abnormalities in a subject's skin, the method being configured to be performed on a system comprising a scanner, a remodeling processor, a prediction processor, a control unit, a touch-screen panel and one or more energy projecting systems, the method including: 1) scanning, using the scanner, a 2D image of the subject's skin from multiple angles to capture one or more feature points, the one or more feature points correspond to physical attributes of the subject; 2) constructing, using the remodeling processor, a 3D model of the subject's skin by depth estimation of the 2D image to form a new image and depth-based rendering of the new image to form a stereo pair; 3) receiving, by the prediction processor, a reference model of the subject; 4) determining, by the prediction processor, a first set of parameters and a second set of parameters corresponding to the one or more feature points of the reference model and a test model, respectively, of the subject, wherein the first set of parameters and the second set of parameters correspond to properties of the reference model and the test model, respectively; 5) determining, by the prediction processor, the plurality of parameters by comparing the first set of parameters and the second set of parameters; and 6) displaying, by the touch-screen panel, the plurality of parameters to a user.

Aspects A and B may have one or more of the following additional elements in combination: Element 1: further including one or more energy projecting systems configured to direct the plurality of parameters displayed by the touch-screen panel, on fat planes that are identified on the subject's skin. Element 2: wherein the system works in any one of an automatic manner and in a semi-automatic manner, wherein in the automatic manner, the control unit directly transmits the plurality of parameters to one or more energy projecting systems and in the semi-automatic manner, the control unit transmits the plurality of parameters to the touch-screen panel. Element 3: wherein the scanner is at least one selected from a group consisting of a camera, a video camera, a stereo photography 3dMD, a structured light facial scanner, a high-accuracy industrial line-laser scanner and a combination thereof. Element 4: wherein the one or more feature points of the subject's skin are determined by any one of automatic manner and a manual manner. Element 5: wherein the control unit is configured to adjust the plurality of parameters of one or more energy projecting systems, the plurality of parameters being selected from a group consisting of temperature, pressure, time duration, magnitude and intensity of energy applied, angular motion, direction of movement and combinations thereof. Element 6: further including one or more energy projecting systems (140), and further wherein the one or more energy projecting systems are selected from a group consisting of radiofrequency devices, ultrasound devices, and laser devices. Element 7: wherein the system is configured to enhance an efficacy by iterative use thereof, based on the plurality of parameters. Element 8: wherein the first set of parameters and the second set of parameters correspond to properties of a reference model and a test model of the subject respectively. Element 9: further including a remodeling system, and further wherein the remodeling system comprises an artificial intelligence (AI) technique for comparing a reference model with a test model for obtaining the plurality of parameters. Element 10: wherein the reference model corresponds to a non-real-time model of the subject and the test model corresponds to a real-time model of the subject. Element 11: wherein the reference model corresponds to a non-real-time model of the subject and the test model corresponds to a real-time model of the subject. Element 12: further including directing the plurality of parameters suggested by the touch-screen panel on fat planes, that are identified on the subject's skin, by the one or more energy projecting systems. Element 13: wherein the method works in any one of an automatic manner or in a semi-automatic manner, wherein in the automatic manner, the control unit directly transmits the plurality of parameters to the one or more energy projecting systems. Element 14: wherein the scanner is at least one selected from a group consisting of a camera, a video camera, a stereo photography 3dMD, a structured light facial scanner, a high-accuracy industrial line-laser scanner and a combination thereof. Element 15: wherein the one or more feature points of the subject's skin are determined by any one of automatic manner and a manual manner. Element 16: wherein the control unit is configured for adjusting the plurality of parameters of the one or more energy projecting systems, the plurality of parameters being selected from a group consisting of temperature, pressure, time duration, magnitude and intensity of energy applied, angular motion, direction of movement and combinations thereof. Element 17: wherein the one or more energy projecting systems are selected from a group consisting of radiofrequency devices, ultrasound devices, and laser devices. Element 18: further including a remodeling system, and further wherein the remodeling system is configured to use one or more artificial intelligence (AI) techniques for determining the plurality of parameters.

1. A system of identifying a plurality of parameters related to abnormalities in a subject's skin, the system comprising:
a scanner configured to scan a 2D image of the subject's skin from multiple angles to capture one or more feature points, the one or more feature points correspond to physical attributes of the subject;
a remodeling processor configured to construct a 3D model of the subject's skin by depth estimation of the 2D image to form a new image and depth-based rendering of the new image to form a stereo pair;
a control unit comprising a prediction processor, the prediction processor configured to determine a first set of parameters and a second set of parameters corresponding to the one or more feature points; and
a touch-screen panel configured to display the plurality of parameters to a physician/user, wherein the plurality of parameters are determined by the prediction processor using the first set of parameters and the second set of parameters.

2. The system as claimed in claim 1, further including one or more energy projecting systems configured to direct the plurality of parameters displayed by the touch-screen panel, on fat planes that are identified on the subject's skin.

3. The system as claimed in claim 1, wherein the system works in any one of an automatic manner and in a semi-automatic manner, wherein in the automatic manner, the control unit directly transmits the plurality of parameters to one or more energy projecting systems and in the semi-automatic manner, the control unit transmits the plurality of parameters to the touch-screen panel.

4. The system as claimed in claim 1, wherein the scanner is at least one selected from a group consisting of a camera, a video camera, a stereo photography 3dMD, a structured light facial scanner, a high-accuracy industrial line-laser scanner and a combination thereof.

5. The system as claimed in claim 1, wherein the one or more feature points of the subject's skin are determined by any one of automatic manner and a manual manner.

6. The system as claimed in claim 1, wherein the control unit is configured to adjust the plurality of parameters of one or more energy projecting systems, the plurality of parameters being selected from a group consisting of temperature, pressure, time duration, magnitude and intensity of energy applied, angular motion, direction of movement and combinations thereof.

7. The system as claimed in claim 1, further including one or more energy projecting systems, and further wherein the one or more energy projecting systems are selected from a group consisting of radiofrequency devices, ultrasound devices, and laser devices.

8. The system as claimed in claim 1, wherein the system is configured to enhance an efficacy by iterative use thereof, based on the plurality of parameters.

9. The system as claimed in claim 1, wherein the first set of parameters and the second set of parameters correspond to properties of a reference model and a test model of the subject respectively.

10. The system as claimed in claim 1, further including a remodeling system, and further wherein the remodeling system comprises an artificial intelligence (AI) technique for comparing a reference model with a test model for obtaining the plurality of parameters.

11. The system as claimed in claim 10, wherein the reference model corresponds to a non-real-time model of the subject and the test model corresponds to a real-time model of the subject.

12. A method of identifying a plurality of parameters related to abnormalities in a subject's skin, the method being configured to be performed on a system comprising a scanner, a remodeling processor, a prediction processor, a control unit, a touch-screen panel and one or more energy projecting systems, the method comprising:
scanning, using the scanner, a 2D image of the subject's skin from multiple angles to capture one or more feature points, the one or more feature points correspond to physical attributes of the subject;
constructing, using the remodeling processor, a 3D model of the subject's skin by depth estimation of the 2D image to form a new image and depth-based rendering of the new image to form a stereo pair;
receiving, by the prediction processor, a reference model of the subject;
determining, by the prediction processor, a first set of parameters and a second set of parameters corresponding to the one or more feature points of the reference model and a test model, respectively, of the subject, wherein the first set of parameters and the second set of parameters correspond to properties of the reference model and the test model, respectively;
determining, by the prediction processor, the plurality of parameters by comparing the first set of parameters and the second set of parameters; and
displaying, by the touch-screen panel, the plurality of parameters to a user.

13. The method as claimed in claim 12, wherein the reference model corresponds to a non-real-time model of the subject and the test model corresponds to a real-time model of the subject.

14. The method as claimed in claim 12, further including directing the plurality of parameters suggested by the touch-screen panel on fat planes, that are identified on the subject's skin, by the one or more energy projecting systems.

15. The method as claimed in claim 12, wherein the method works in any one of an automatic manner or in a semi-automatic manner, wherein in the automatic manner, the control unit directly transmits the plurality of parameters to the one or more energy projecting systems.

16. The method as claimed in claim 12, wherein the scanner is at least one selected from a group consisting of a camera, a video camera, a stereo photography 3dMD, a structured light facial scanner, a high-accuracy industrial line-laser scanner and a combination thereof.

17. The method as claimed in claim 12, wherein the one or more feature points of the subject's skin are determined by any one of automatic manner and a manual manner.

18. The method as claimed in claim 12, wherein the control unit is configured for adjusting the plurality of parameters of the one or more energy projecting systems, the plurality of parameters being selected from a group consisting of temperature, pressure, time duration, magnitude and intensity of energy applied, angular motion, direction of movement and combinations thereof.

19. The method as claimed in claim 12, wherein the one or more energy projecting systems are selected from a group consisting of radiofrequency devices, ultrasound devices, and laser devices.

20. The method as claimed in claim 12, further including a remodeling system, and further wherein the remodeling system is configured to use one or more artificial intelligence (AI) techniques for determining the plurality of parameters.
